(19) United States
(12) Patent Application Publication
(10) Pub. No.: US 2024/0251217 A1
(43) Pub. Date: Jul. 25, 2024

(54) AUDIO CONTENT PROVIDING APPARATUS, CONTROL METHOD, AND COMPUTER-READABLE MEDIUM

(71) Applicant: NEC CORPORATION, Tokyo (JP)

(72) Inventors: Yuki HASHIMOTO, Tokyo (JP); Goh Shibata, Tokyo (JP); Takayuki Sasaki, Tokyo (JP); Dai Yokoi, Tokyo (JP)

(73) Assignee: NEC Corporation, Minato-ku, Tokyo (JP)

(21) Appl. No.: 18/290,341

(22) PCT Filed: May 18, 2021
(86) PCT No.: PCT/JP2021/018819

§ 371 Date: Nov. 13, 2023

(51) Int. Cl. H04S 7/00; G01S 15/08

(52) U.S. Cl. CPC H04S 7/302; G01S 15/08; H04S 2400/11

(57) ABSTRACT

An audio content providing apparatus (2000) acquires user position information (80) that indicates a user position (30). The audio content providing apparatus (2000) sets a sound image localization position (50) on the basis of the user position (30) and a reference position (40), in a case where a user (20) is present in a target region (70). Here, a distance between the user position (30) and the sound image localization position (50) is shorter than a distance between the user position (30) and the reference position (40). The audio content providing apparatus (2000) outputs audio content (10) such that a sound image is localized at the sound image localization position (50).

### TECHNICAL FIELD

The present disclosure relates to technology for controlling a position of sound image localization.

### BACKGROUND ART

Techniques for controlling a position at which a sound image of audio content is localized when the audio content is provided to a user have been developed. Patent Literatures 1 to 3 disclose such technologies. Patent Literature 1 discloses a technique for selecting any one of an ear of a passenger and a standard position as a position of sound image localization of a notification sound when the notification sound is output in a vehicle. Patent Literatures 2 and 3 disclose techniques for determining a position of sound image localization of audio content according to a state (position or type of behavior) of a user.

### CITATION LIST

### Patent Literature

Patent Literature 1: Japanese Unexamined Patent Application Publication No. 2019-016971
Patent Literature 2: International Patent Publication No. WO 2018/092486
Patent Literature 3: International Patent Publication No. WO 2016/185740

### SUMMARY OF INVENTION

### Technical Problem

The sound image localization position disclosed in Citation List is 1) a predetermined standard position, or 2) a relative position with respect to the user position determined without considering the standard position. Therefore, a technique for using a position other than 1) and 2) as the sound image localization position is not disclosed. The present invention has been made in view of the above problems, and an objective of the present invention is to provide a new technique for determining a sound image localization position of audio content.

### Solution to Problem

An audio content providing apparatus of the present disclosure includes: an acquisition unit configured to acquire user position information indicating a position of a user; a setting unit configured to set a sound image localization position at which a sound image of audio content to be provided to the user is localized, on the basis of a reference position regarding a target object, place, or event and the user position, in a case where the user is present in a predetermined region; and an output control unit configured to output the audio content such that the sound image is localized at the sound image localization position. A distance between the user position and the sound image localization position is shorter than a distance between the user position and the reference position.

A control method of the present disclosure is executed by a computer. The control method includes: an acquisition step of acquiring user position information indicating a position of a user; a setting step of setting a sound image localization position at which a sound image of audio content to be provided to the user is localized on the basis of a reference position regarding a target object, place, or event and the user position, in a case where the user is present in a predetermined region; and an output control step of outputting the audio content such that the sound image is localized at the sound image localization position. A distance between the user position and the sound image localization position is shorter than a distance between the user position and the reference position.

A computer-readable medium of the present disclosure stores a program for causing a computer to execute the control method of the present disclosure.

### Advantageous Effects of Invention

According to the present disclosure, a new technique for determining a sound image localization position of audio content is provided.

### BRIEF DESCRIPTION OF DRAWINGS

FIG. 1 is a diagram illustrating an overview of an operation of an audio content providing apparatus according to a first example embodiment.

FIG. 2 is a block diagram illustrating a functional configuration of the audio content providing apparatus according to the first example embodiment.

FIG. 3 is a block diagram illustrating a hardware configuration of a computer that realizes the audio content providing apparatus.

FIG. 4 is a flowchart illustrating a flow of processing executed by the audio content providing apparatus according to the first example embodiment.

FIG. 5 is a diagram illustrating a case where a sound image localization position is located between a user position and a reference position.

FIG. 6 is a diagram illustrating a case where a sound image localization position is located in a direction opposite to a reference position as viewed from a user.

FIG. 7 is a diagram illustrating a case where a sound image localization position is located in a region determined on the basis of a user position and a reference position.

FIG. 8 is a diagram illustrating a case where a plurality of sound image localization positions is used in order of being distant from a user position.

FIG. 9 is a diagram illustrating a case where a sound image localization position approaches a user position with time and then passes the user position.

FIG. 10 is a diagram illustrating a case where a sound image localization position 50 is set using an expected position of a user.

FIG. 11 is a diagram illustrating a case where a reference position is outside a target region.

FIG. 12 is a diagram illustrating a case where a plurality of partial audio contents is output.

FIG. 13 is a diagram illustrating an overview of an operation of an audio content providing apparatus according to a second example embodiment.

FIG. 14 is a block diagram illustrating a functional configuration of the audio content providing apparatus according to the second example embodiment.

FIG. 15 is a flowchart illustrating a flow of processing executed by the audio content providing apparatus according to the second example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated description is omitted as necessary for clarity of description. Further, unless otherwise described, predetermined values such as prescribed values and threshold values are stored in advance in a storage device or the like accessible from an apparatus using the values. Furthermore, unless otherwise described, a storage unit includes one or more storage devices of any number.

### First Example Embodiment

### <Overview>

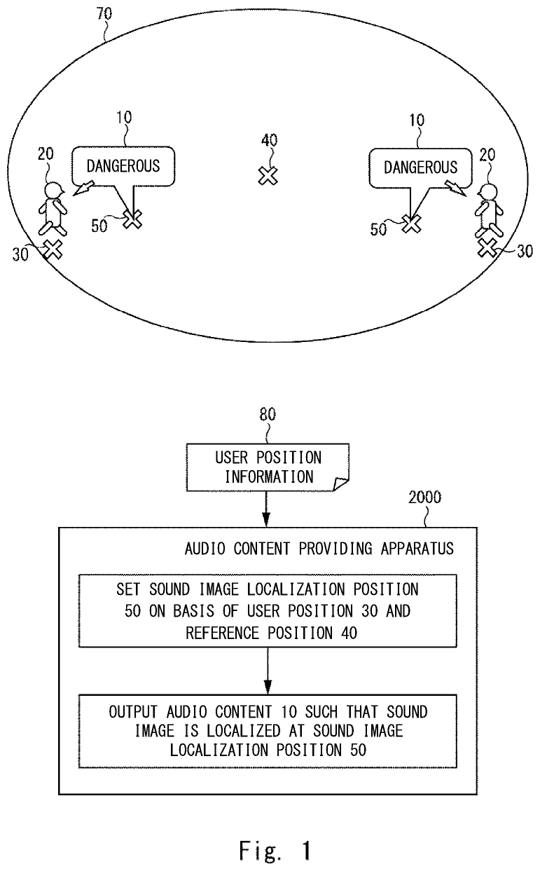

FIG. 1 is a diagram illustrating an overview of an operation of an audio content providing apparatus 2000 according to a first example embodiment. Here, FIG. 1 is a diagram for facilitating understanding of the overview of the audio content providing apparatus 2000, and the operation of the audio content providing apparatus 2000 is not limited to that illustrated in FIG. 1.

The audio content providing apparatus 2000 controls a position of sound image localization (sound image localization position 50) for audio content 10 to be provided to a user 20. The audio content 10 is any content that is provided to the user 20 audibly and that is related to a target object, place, or event. Hereinafter, the target object, place, or event is also referred to as the “target object or the like”.

The target object or the like is arbitrary. For example, the target object or the like is an object or the like that is a target of guidance to the user 20. The guidance to the user 20 is, for example, a warning, event information of a facility, coupon information, road guidance, traffic information, tourist information, event information of a facility, or traffic information. Suppose that the guidance is a warning. In this case, the object to be the guidance target is an object that is dangerous itself (e.g., heavy machinery), an object used for a dangerous work, or the like. Further, the place to be the guidance target is a place where a dangerous work is performed or the like. Further, the event to be the guidance target is a dangerous work (construction, transportation of a dangerous object, or the like) or the like.

In addition, for example, the target object or the like is an object or the like related to an event provided to the user 20. Suppose that the event provided to the user 20 is a fireworks display. In this case, the target object is a firework. Further, the target place is a place where the user 20 views the firework. Further, the target event is a fireworks display.

The audio content 10 is provided to the user 20 present in a target region 70. Suppose that the audio content 10 represents guidance to the user 20. In this case, a region where guidance using the audio content 10 is desired to be provided is set as the target region 70. Suppose that the guidance is a warning. In this case, a region where it is necessary to call attention of the user 20 (e.g., a region around a place where a heavy machine is used) is set as the target region 70.

In order to provide the audio content 10 to the user 20 (reproduce the audio content 10 so that the user 20 can hear it), the audio content providing apparatus 2000 sets a position based on a user position 30 and a reference position 40 as the sound image localization position 50, which is a position of sound image localization of the audio content 10. Then, the audio content providing apparatus 2000 outputs the audio content 10 such that the set sound image localization position 50 is the position of the sound image localization of the audio content 10.

The reference position 40 is a position determined in relation to the target object or the like. For example, the reference position 40 is a position of the target object, a position of the target place, or a position where the target event is performed. In addition, for example, the reference position 40 may be a position near the target object, a position near the target place, or a position near the position where the target event is performed.

For the user 20 present in the target region 70, the audio content providing apparatus 2000 acquires user position information 80 that indicates the user position 30, which is the position of the user 20. Further, the audio content providing apparatus 2000 sets the sound image localization position 50 on the basis of the user position 30 and the reference position 40. Then, the audio content providing apparatus 2000 outputs the audio content 10 such that the sound image of the audio content 10 is localized at the sound image localization position 50. Note that the user position 30, the reference position 40, and the sound image localization position 50 may be represented by the coordinates (for example, the coordinates representing the position in a plan view) on a two-dimensional space, or may be represented by the coordinates on a three-dimensional space.

Here, the sound image localization position 50 is set such that a distance between the user position 30 and the sound image localization position 50 is shorter than a distance between the user position 30 and the reference position 40. For example, the sound image localization position 50 is set at a position between the user position 30 and the reference position 40.

Note that the audio content providing apparatus 2000 does not necessarily set the sound image localization position 50 on the basis of the user position 30 and the reference position 40 every time. For example, as described in a second example embodiment that will be described later, the audio content providing apparatus 2000 may be configured to use a position based on the user position 30 and the reference position 40 as the sound image localization position 50 in a case where a predetermined condition is satisfied, and use the reference position 40 as the sound image localization position 50 in a case where the condition is not satisfied.

### Example of Advantageous Effect

According to the audio content providing apparatus 2000 of the first example embodiment, the sound image localization position 50 is set on the basis of the user position 30 and the reference position 40, and the audio content 10 is output such that the sound image of the audio content 10 is localized at the sound image localization position 50. As described above, according to the audio content providing apparatus 2000, there is provided a new technique of setting the position determined on the basis of the reference position and the user position as the position at which the sound image of the audio content is localized.

Further, the distance between the user position 30 and the sound image localization position 50 is shorter than the distance between the user position 30 and the reference position 40. For this reason, the user 20 perceives that the audio content 10 is output at a position closer to the user than the reference position 40. Therefore, the audio content 10 can be output such that an impression on the user 20 becomes stronger as compared with a case where the sound image of the audio content 10 is localized at the reference position 40.

For example, in a case where the audio content 10 represents guidance for the user 20, by localizing the sound image of the audio content 10 at the sound image localization position 50, an impression of the guidance becomes stronger for the user 20 as compared with the case where the sound image of the audio content 10 is localized at the reference position 40. Therefore, it is possible to prevent the user 20 from missing the guidance or the user 20 from neglecting the guidance.

Suppose that the guidance is a warning. In this case, a warning having a stronger impression can be given to the user 20. As a result, since it is possible to cause the user 20 to be more strongly conscious of a dangerous situation, it is possible to prompt the user 20 to take quicker measures (avoidance action or the like).

Further, suppose that the audio content 10 is content for an object or the like related to an event to be provided to the user 20. In this case, by localizing the sound image of the audio content 10 at the sound image localization position 50, the impression of the event becomes stronger for the user 20 (for example, the event is more powerful) as compared with the case where the sound image of the audio content 10 is localized at the reference position 40. Therefore, a more attractive event can be provided to the user 20.

Hereinafter, the audio content providing apparatus 2000 of the present example embodiment will be described in more detail.

### Example of Functional Configuration

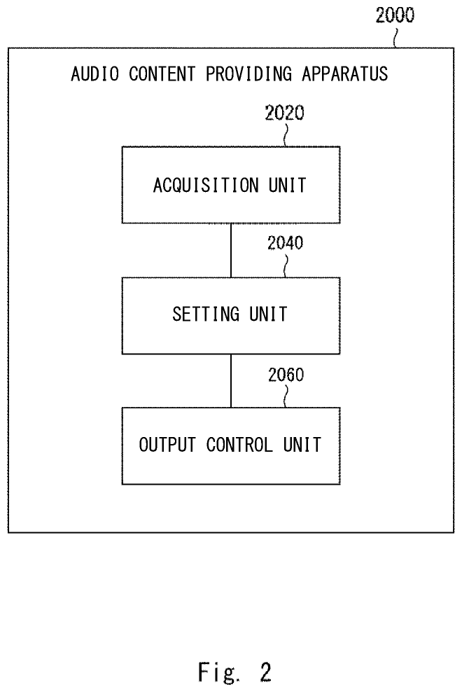

FIG. 2 is a block diagram illustrating a functional configuration of the audio content providing apparatus 2000 according to the first example embodiment. The audio content providing apparatus 2000 has an acquisition unit 2020, a setting unit 2040, and an output control unit 2060. The acquisition unit 2020 acquires the user position information 80 indicating the user position 30. The setting unit 2040 sets the sound image localization position 50 (the position of the sound image localization of the audio content 10 to be provided to the user 20) on the basis of the user position 30 and the reference position 40.

The output control unit 2060 outputs the audio content 10 such that the sound image of the audio content 10 is localized at the sound image localization position 50.

### Example of Hardware Configuration

Each functional configuration unit of the audio content providing apparatus 2000 may be realized by hardware (for example, a hard-wired electronic circuit or the like) that realizes each functional configuration unit, or may be realized by a combination of hardware and software (for example, a combination of an electronic circuit and a program that controls the electronic circuit or the like). Hereinafter, a case where each functional configuration unit of the audio content providing apparatus 2000 is realized by a combination of hardware and software will be further described.

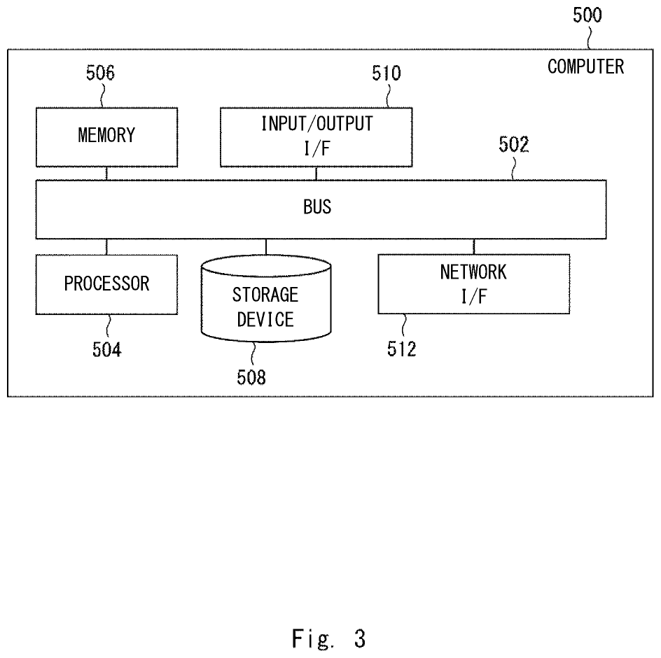

FIG. 3 is a block diagram illustrating a hardware configuration of a computer 500 that realizes the audio content providing apparatus 2000. The computer 500 is any computer. For example, the computer 500 is a stationary computer such as a personal computer (PC) or a server machine. In addition, for example, the computer 500 is a portable computer such as a smartphone or a tablet terminal. The computer 500 may be a special-purpose computer designed to realize the audio content providing apparatus 2000, or may be a general-purpose computer.

For example, by installing a predetermined application in the computer 500, each function of the audio content providing apparatus 2000 is realized by the computer 500. The application includes a program for realizing each functional configuration unit of the audio content providing apparatus 2000. Note that a method for acquiring the program is arbitrary. For example, the program can be acquired from a storage medium (a DVD disk, a USB memory, or the like) in which the program is stored. In addition, for example, the program can be acquired by downloading the program from a server apparatus that manages a storage device in which the program is stored.

The computer 500 has a bus 502, a processor 504, a memory 506, a storage device 508, an input/output interface 510, and a network interface 512. The bus 502 is a data transmission path for the processor 504, the memory 506, the storage device 508, the input/output interface 510, and the network interface 512 to transmit and receive data to and from each other. However, the method for connecting the processor 504 and the like to each other is not limited to the bus connection.

The processor 504 is various processors such as a central processing unit (CPU), a graphics processing unit (GPU), and a field-programmable gate array (FPGA). The memory 506 is a main storage device realized by using a random access memory (RAM) or the like. The storage device 508 is an auxiliary storage device realized by using a hard disk, a solid state drive (SSD), a memory card, or a read only memory (ROM).

The input/output interface 510 is an interface for connecting the computer 500 and an input/output device. For example, an input apparatus such as a keyboard and an output apparatus such as a display apparatus are connected to the input/output interface 510.

The network interface 512 is an interface for connecting the computer 500 to a network. The network may be a local area network (LAN), or may be a wide area network (WAN).

The storage device 508 stores a program (program for realizing the above-described application) for realizing each functional configuration unit of the audio content providing apparatus 2000. The processor 504 reads the program to the memory 506 and executes the program to realize each functional configuration unit of the audio content providing apparatus 2000.

The audio content providing apparatus 2000 may be realized by one computer 500, or may be realized by a plurality of computers 500. In the latter case, the configurations of the computers 500 do not need to be the same, and can be different from each other.

### <Flow of Processing>

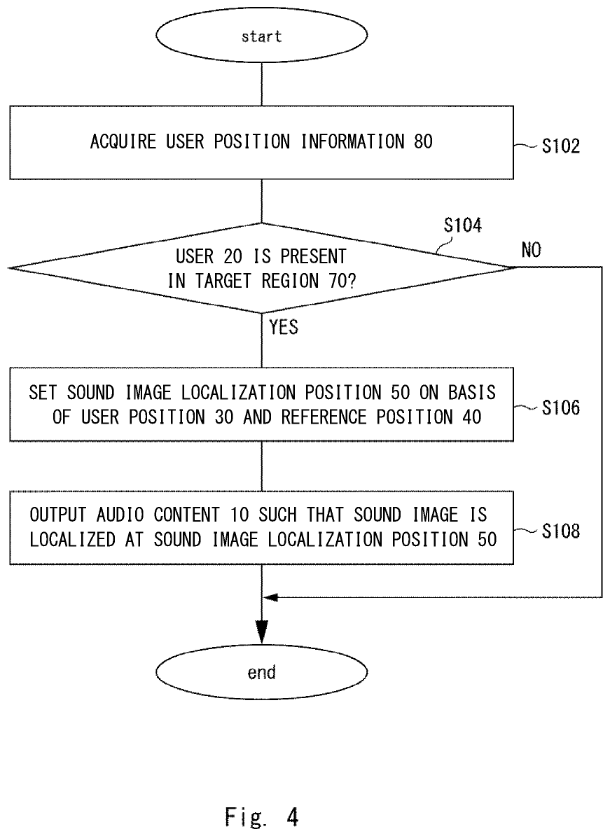

FIG. 4 is a flowchart illustrating a flow of processing executed by the audio content providing apparatus 2000 according to the first example embodiment. The acquisition unit 2020 acquires the user position information 80 (S102). The setting unit 2040 determines whether or not the user 20 is present in the target region 70 (S104). When the user 20 is not present in the target region 70 (S104: NO), the processing of FIG. 4 ends. On the other hand, when the user 20 is present in the target region 70 (S104: YES), the setting unit 2040 sets the sound image localization position 50 using the user position 30 and the reference position 40 (S106). The output control unit 2060 outputs the audio content 10 such that the sound image of the audio content 10 is localized at the sound image localization position 50 (S108). <Acquisition of user position information 80: S102>

The acquisition unit 2020 acquires the user position information 80 (S102). The user position information 80 is information that indicates the user position 30, which is the position of the user 20. There are various methods for the acquisition unit 2020 to acquire the user position information 80. For example, the acquisition unit 2020 acquires the user position information 80 by receiving the user position information 80 transmitted from an apparatus (hereinafter, the user position information generation apparatus) that generates the user position information 80. In addition, for example, the acquisition unit 2020 may acquire the user position information 80 by accessing a storage unit in which the user position information 80 is stored.

Here, there are various methods for generating the user position information 80. For example, the user position information 80 is generated by the user position information generation apparatus including a global positioning system (GPS) sensor. In this case, the user position 30 may be represented by the GPS coordinates obtained from the GPS sensor, or may be represented by other coordinates (for example, a pair of latitude and longitude) obtained by applying predetermined conversion to the GPS coordinates. Further, in this case, the user position information generation apparatus can be an arbitrary terminal that includes the GPS sensor and moves together with the user 20. For example, the user position information generation apparatus is a terminal carried by the user 20, a terminal worn by the user 20, a terminal provided on an object (baggage, carriage, or the like) moved by the user 20, or a terminal provided on a vehicle used by the user 20 for movement.

A method for generating the user position information 80 is not limited to a method using the GPS sensor. For example, the user position information 80 may be generated by analyzing a captured image generated by a camera capable of capturing a place where the user 20 moves. In this case, for example, the user position information generation apparatus is a camera that captures the user 20. In addition, for example, the user position information generation apparatus may be any apparatus (a server apparatus or the like) that acquires a captured image from the camera and performs analysis.

In a case where the user position 30 is determined using the captured image, for example, the user position 30 is computed on the basis of a position of the camera and a position on the image of the user 20 included in the captured image generated by the camera. Note that an existing technique can be used as a technique to determine a position of an object in the real world on the basis of a position of the camera that captures the object and a position of the object on the image. <Determination as to whether or not user 20 is present in target region 70: S104>

The setting unit 2040 determines whether or not the user 20 is present in the target region 70 (S104). Specifically, the setting unit 2040 determines whether or not the user position 30 indicated by the user position information 80 is included in the target region 70. In a case where the user position 30 is included in the target region 70, the setting unit 2040 determines that the user 20 is present in the target region 70. On the other hand, in a case where the user position 30 is not included in the target region 70, the setting unit 2040 determines that the user 20 is not present in the target region 70.

In order to perform the determination, the setting unit 2040 acquires information that indicates the target region 70 (hereinafter, target region information). The target region information indicates a range included in the target region 70 (for example, a range of a GPS coordinate space included in the target region 70).

Here, in a case where there is a plurality of target regions 70, for example, the setting unit 2040 acquires target region information for each target region 70, and determines whether or not the user 20 is present in the target region 70 for each target region 70.

Note that, although the target region 70 is drawn as an oval region in FIG. 1, the shape of the target region 70 is not limited to the oval shape, and may be a region having any shape such as a circle, a rectangle, or a polygon. Further, the shape of the target region 70 is not limited to a shape for which a specific name is defined, such as a circle, and may be any shape for which a specific name is not defined.

Examples of the shape for which the specific name is not defined include a shape freely set by handwriting input by a person who operates the audio content providing apparatus 2000. In addition, examples of the shape for which the specific name is not defined include a shape formed by combining a plurality of shapes for which a specific name is defined, such as a circle. Note that, when a plurality of shapes is combined, these shapes may partially overlap each other or may not overlap each other. Examples of the former include a shape in which a plurality of circles are arranged such that adjacent parts overlap each other.

As a condition for providing the audio content 10, instead of the condition that “the user 20 is present in the target region 70”, a condition that “the user 20 has entered the target region 70” may be used. The condition that “the user 20 has entered the target region 70” is satisfied, for example, when a state of “the user 20 is not present in the target region 70” transitions to a state of “the user 20 is present in the target region 70”.

### <Determination of Reference Position 40>

The sound image localization position 50 is set on the basis of the user position 30 and the reference position 40. Therefore, for the target region 70 in which the user 20 is present, the setting unit 2040 determines the reference position 40 corresponding to the target region 70. For example, the reference position 40 is stored in advance in the storage unit in association with identification information of the target region 70. In this case, the setting unit 2040 acquires, from the storage unit, the reference position 40 associated with the identification information of the target region 70 in which the user 20 is determined to be present.

The reference position 40 corresponding to the target region 70 is not limited to a position fixed in advance. Suppose that the reference position 40 is a position of a target object and the object is movable. In this case, the setting unit 2040 determines the position of the target object and uses the position as the reference position 40.

Here, as a method for determining the position of the target object, a method similar to the method for determining the position of the user can be used. For example, a terminal having a GPS sensor is attached to the target object, and the position of the target object can be determined using the GPS coordinates obtained from the GPS sensor. In addition, for example, the position of the target object may be determined by analyzing a captured image obtained by capturing the target object with a camera.

In another example, at an arbitrary position (for example, a position of the target place or a position where the target event is to be performed) to be handled as the reference position 40, it is possible to install a terminal having a GPS sensor to grasp that position or install a marker to indicate that position. In the former case, the reference position 40 can be determined by using the GPS coordinates or the like obtained from the GPS sensor. In the latter case, the reference position 40 can be determined by analyzing a captured image obtained by capturing the marker with the camera.

Note that, in a case where the reference position 40 is not fixed as described above, information regarding what is used to determine the reference position 40 is stored in the storage unit in advance in association with the identification information of the target region 70. In a case where the terminal having the GPS sensor is used to determine the reference position 40, for example, identification information of the terminal is associated with the identification information of the target region 70. In a case where the marker is used to determine the reference position 40, for example, a feature value of the marker on the image is associated with the identification information of the target region 70. In a case where the position of the target object is determined using the captured image, for example, a feature value of the target object on the image is associated with the identification information of the target region 70.

<Setting of sound image localization position 50: S106>

When the user 20 is present in the target region 70 (S104: YES), the setting unit 2040 sets the sound image localization position 50 on the basis of the user position 30 and the reference position 40 (S106). The sound image localization position 50 is set such that the distance between the user position 30 and the sound image localization position 50 is shorter than the distance between the user position 30 and the reference position 40.

Various methods can be adopted as a method for setting the sound image localization position 50. Hereinafter, some methods for setting the sound image localization position 50 will be exemplified.

For example, the setting unit 2040 sets a position between the user position 30 and the reference position 40 as the sound image localization position 50. As described above, by setting the sound image localization position 50 between the user position 30 and the reference position 40, when the audio content 10 is output, it is possible to cause the user 20 to naturally look at the reference position while causing the user 20 to feel that the audio content 10 is output from a position closer than the reference position 40. Therefore, it is possible to cause the user 20 to strongly notice an event related to the target object or the like through both hearing and vision.

Suppose that the audio content 10 is a sound that indicates a warning. In this case, when the sound image localization position 50 is set between the user position 30 and the reference position 40 and the audio content 10 is output, the user 20 can visually notice an object or the like to be warned (for example, a heavy machine operating at a construction site or the like) while audibly recognizing the audio content 10 as if the audio content is output from a position closer than the reference position 40. Therefore, the user 20 can take an appropriate action such as an avoidance action while being more strongly conscious of the situation in which the user is placed and understanding the situation more accurately.

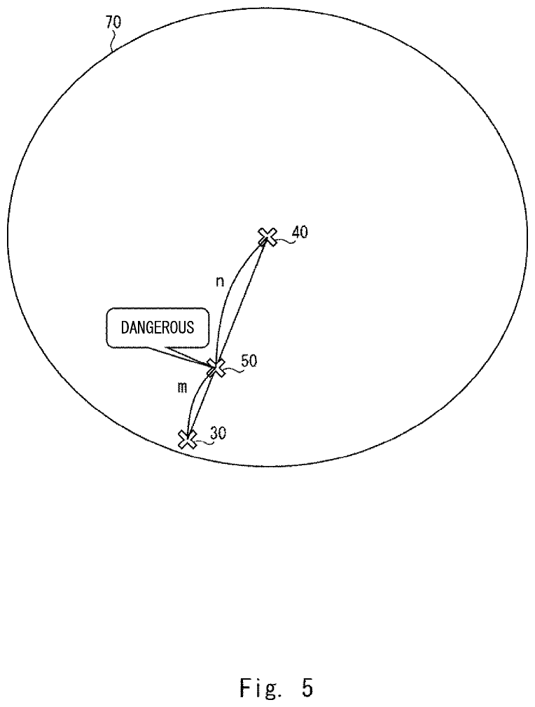

FIG. 5 is a diagram illustrating a case where the sound image localization position 50 is located between the user position 30 and the reference position 40. In FIG. 5, the sound image localization position 50 is a point on a line segment connecting the user position 30 and the reference position 40. Various methods can be adopted as to which position on the line segment is set as the sound image localization position 50. For example, the distance between the user position 30 and the sound image localization position 50 is fixed. In this case, the setting unit 2040 sets a position that is on the line segment connecting the user position 30 and the reference position 40 and that is separated from the user position 30 by a predetermined distance, as the sound image localization position 50.

In addition, for example, a ratio of a length of a line segment connecting the user position 30 and the sound image localization position 50 to a length of a line segment connecting the reference position 40 and the sound image localization position 50 is defined in advance. In FIG. 5, the ratio of the length of the line segment connecting the user position 30 and the sound image localization position 50 to the length of the line segment connecting the reference position 40 and the sound image localization position 50 is defined as m:n. Note that, in a case of m=n, the sound image localization position 50 is a middle point between the user position 30 and the reference position 40.

In a case where the length ratio is determined as described above, for example, the setting unit 2040 computes the distance between the user position 30 and the sound image localization position 50 on the basis of the distance between the user position 30 and the reference position 40 and the ratio. Then, the setting unit 2040 sets a position that is on the line segment connecting the user position 30 and the reference position 40 and that is separated from the user position by the computed distance, as the sound image localization position 50.

In addition, for example, the setting unit 2040 may set the sound image localization position 50 on the basis of a state of the user 20. As a more specific example, the setting unit 2040 computes an index value (hereinafter, the risk index value) indicating a degree to which the user 20 is in a dangerous state, and causes the sound image localization position 50 to approach the user position 30 more as the risk index value is larger.

For example, the ratio of the length of the line segment connecting the user position 30 and the sound image localization position 50 to the length of the line segment connecting the reference position 40 and the sound image localization position 50 is determined by m:αn (α>1). In addition, a is set to be larger as the risk index value is larger (for example, the risk index value is used as a). In this way, the sound image localization position 50 approaches the user position 30 more as the risk index value increases.

Here, various indices can be used as the risk index. For example, the risk is represented by the magnitude of the movement speed of the user 20. In this case, the risk index value is computed as a larger value, as the magnitude of the movement speed of the user 20 is larger. The risk index value may be the magnitude of the movement speed of the user 20, or may be another value computed according to the magnitude of the movement speed of the user 20. In the latter case, for example, it is possible to use a monotonically non-decreasing function that computes a real value according to the input of the magnitude of the movement speed of the user 20 to compute the risk index value. Note that the magnitude of the movement speed of the user 20 can be computed on the basis of a temporal change of the user position 30.

In addition, for example, the risk is represented by how low the probability that the user 20 notices the target object or the like is. In this case, the risk index value is computed as a larger value, as the probability that the user 20 notices the target object or the like is lower. A degree of probability that the user 20 notices the target object or the like is represented by, for example, a degree to which a face of the user 20 faces the reference position 40. In this case, for example, the risk index value is computed as a larger value, as an angle formed by a direction from the user position 30 toward the reference position 40 and a direction of the face of the user 20 is larger.

The risk index value may be the angle, or may be another value computed according to the magnitude of the angle. In the latter case, for example, it is possible to use a monotonically non-decreasing function that computes a real value according to the input of the angle formed by the direction from the user position 30 toward the reference position 40 and the direction of the face of the user 20 to compute the risk index value.

Here, there are various methods for computing the direction of the face of the user 20. For example, the direction of the face of the user 20 can be computed by analyzing a captured image obtained by capturing the user 20 with a camera. In addition, for example, the direction of the face of the user 20 can be grasped by using a sensor (acceleration sensor or the like) provided in a manner that the direction of the face of the user 20 can be grasped. Suppose that the audio content 10 is output from a reproduction apparatus (an earphone, a headphone, or the like) worn by the user 20. In this case, it is conceivable to provide a sensor such as an acceleration sensor in the reproduction apparatus.

In addition, for example, the risk is represented by how high the probability that the user 20 moves toward the target object or the like is. In this case, the risk index value is computed as a larger value, as the probability that the user 20 moves toward the target object or the like is higher. As a more specific example, the risk index value is computed as a larger value, as an angle formed by the direction from the user position 30 toward the reference position 40 and the movement direction of the user 20 is smaller.

The risk index value may be the angle, or may be another value computed according to the magnitude of the angle. In the latter case, for example, it is possible to use a monotonically non-increasing function that computes a real value according to the input of the angle formed by the direction from the user position 30 toward the reference position 40 and the movement direction of the user 20 to compute the risk index value. Note that the movement direction of the user 20 can be computed on the basis of a temporal shift of the user position 30.

The risk index value indicating “the probability that the user 20 moves toward the target object or the like” may be computed on the basis of the magnitude of an entry angle when the user 20 enters the target region 70. Specifically, the risk index value is set to be larger as the entry angle is smaller. For example, a monotonically non-increasing function that outputs a real number according to the input of the entry angle is used.

In the above description, the sound image localization position 50 is located between the user position 30 and the reference position 40. However, the sound image localization position 50 may be located in a direction opposite to the reference position 40 from the viewpoint of the user 20.

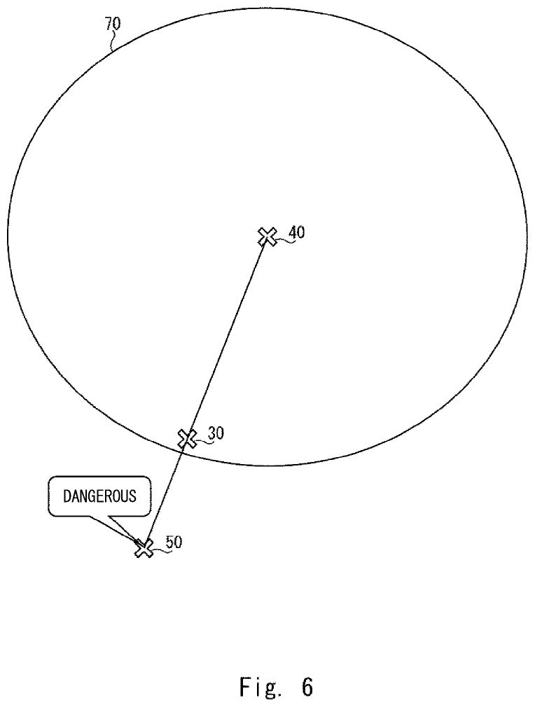

FIG. 6 is a diagram illustrating a case where the sound image localization position 50 is located in the direction opposite to the reference position 40 from the viewpoint of the user 20. In FIG. 6, the sound image localization position 50 is located on a straight line connecting the user position 30 and the reference position 40. In addition, the reference position 40, the user position 30, and the sound image localization position 50 are arranged in this order on the straight line.

As described above, when the sound image localization position 50 is set in the direction opposite to the reference position 40 from the viewpoint of the user 20, the user 20 perceives that the audio content has been output from the rear of the user. In a case where the sound is heard from the rear as described above, it is highly probable that the user 20 stops or reduces the movement speed. Therefore, it is possible to give the user 20 an opportunity to take an appropriate action such as an avoidance action.

In the above description, the sound image localization position 50 is located on the line segment or the straight line connecting the user position 30 and the reference position 40. However, the sound image localization position 50 may be located at a position other than on the line segment or the straight line. In this case, for example, the sound image localization position 50 is located in a region determined on the basis of the user position 30 and the reference position 40.

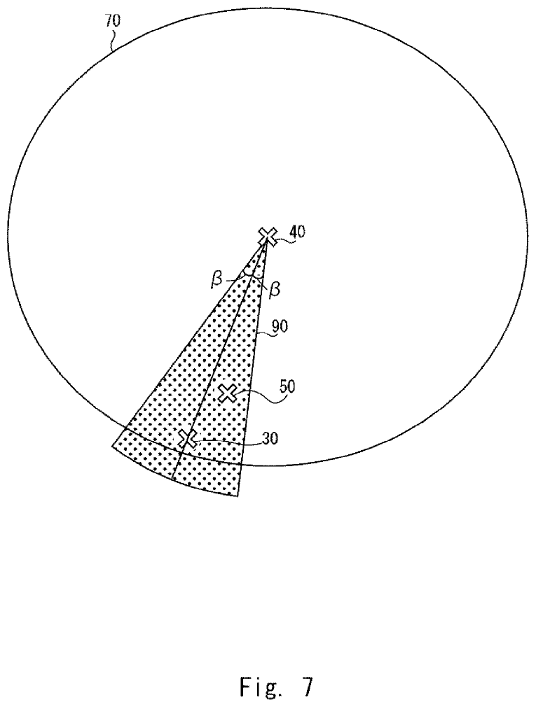

FIG. 7 is a diagram illustrating a case where the sound image localization position 50 is located in a region determined on the basis of the user position 30 and the reference position 40. In FIG. 7, the sound image localization position 50 is included in a fan-shaped region 90 obtained by rotating a line segment passing through the reference position 40 and the user position 30 by +B° around the reference position 40. Here, the magnitude B of the rotation and the length of the line segment are defined in advance. Note that the shape of the region determined on the basis of the user position 30 and the reference position 40 is not limited to a fan shape, and may be any shape.

Note that, even in a case where the sound image localization position 50 is located in the region as illustrated in FIG. 7, it is possible to obtain an effect similar to that in a case where the sound image localization position 50 is located on a straight line connecting the user position 30 and the reference position 40.

The audio content providing apparatus 2000 may set a plurality of sound image localization positions 50 for the audio content 10 and output the sound image localization positions 50 using the plurality of sound image localization positions 50. For example, the audio content providing apparatus 2000 uses the plurality of sound image localization positions 50 at different timings to output the same audio content 10 a plurality of times. As a more specific example, a case is conceivable in which the audio content 10 is perceived to approach the user 20 over time by using the plurality of sound image localization positions 50 in order of being distant from the user position 30 (in order of being close to the reference position 40).

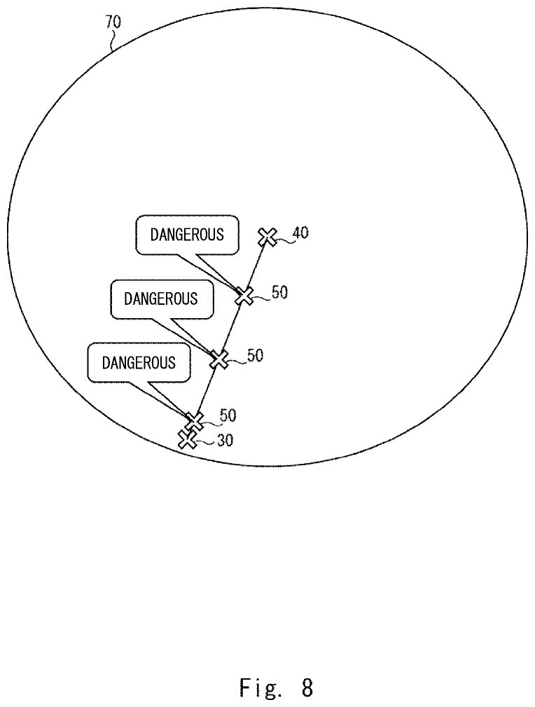

FIG. 8 is a diagram illustrating a case where the plurality of sound image localization positions 50 are used in order of being distant from the user position 30. In FIG. 8, three sound image localization positions 50 (50-1 to 50-3) are set. Then, the audio content providing apparatus 2000 outputs the audio content 10 in order of the audio content 10 subjected to the sound image localization at the sound image localization position 50-1, the audio content 10 subjected to the sound image localization at the sound image localization position 50-2, and the audio content 10 subjected to the sound image localization at the sound image localization position 50-3. In this way, it is possible to cause the user 20 to perceive that the audio content 10 gradually approaches the user.

By causing the user 20 to perceive that the audio content 10 approaches the user as described above, the impression of the audio content 10 is stronger for the user 20 as compared with a case where the sound image of the audio content 10 is localized at only one position. Therefore, it is possible to cause the user 20 to be more strongly conscious of the audio content 10. For example, in a case where the audio content 10 is a sound indicating a warning, it is possible to cause the user 20 to more strongly realize that the user is in a dangerous situation.

Note that, in the example of FIG. 8, the sound image localization position 50 of the audio content 10 that is output last is located between the user position 30 and the reference position 40. However, the audio content providing apparatus 2000 may cause the sound image localization position 50 to approach the user position 30 over time, and then cause the sound image localization position 50 to pass through the user position 30.

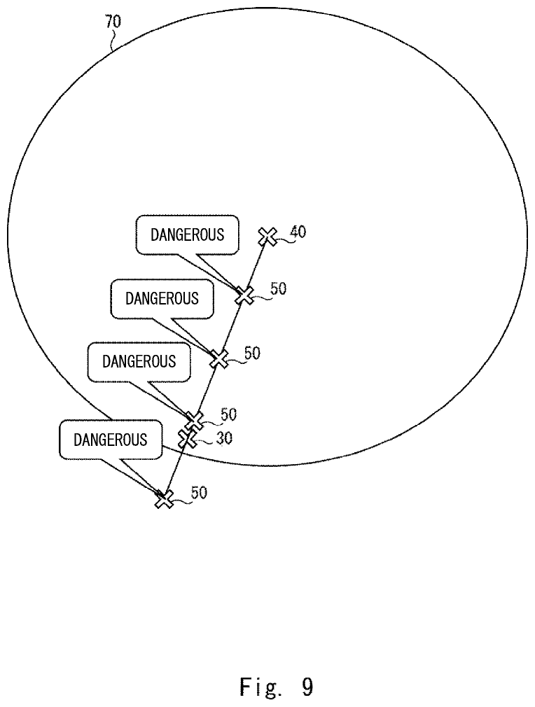

FIG. 9 is a diagram illustrating a case where the sound image localization position 50 approaches the user position 30 over time and then passes through the user position 30. In FIG. 9, in addition to the three sound image localization positions 50-1 to 50-3 in FIG. 8, a sound image localization position 50-4 is set. The audio content providing apparatus 2000 outputs the audio content 10 in the order of the audio content 10 subjected to the sound image localization at the sound image localization position 50-1, the audio content 10 subjected to the sound image localization at the sound image localization position 50-2, the audio content 10 subjected to the sound image localization at the audio content 10 subjected to the sound image localization at the sound image localization position 50-3, and the audio content 10 subjected to the sound image localization at the sound image localization position 50-4.

Here, the sound image localization position 50-4 is located in a direction opposite to the reference position 40 from the viewpoint of the user 20. Therefore, when the audio content 10 is output in the above-described order, the user 20 perceives that the audio content 10 has approached the user and then has passed through the user. As described above, by changing the sound image localization position 50 so as to pass through the user 20, the user 20 can more naturally perceive the sound gradually approaching the user.

The audio content providing apparatus 2000 may set the sound image localization position 50 in consideration of the fact that the user moves over time. As a specific example, the setting unit 2040 uses an expected position of the user 20 at a time point at which the audio content 10 is output or a time point at which the audio content 10 reaches the user 20, in the portion using the user position 30 in each processing described above.

The expected position of the user 20 can be computed, for example, by adding a vector representing the user position 30 and a vector obtained by multiplying a velocity vector of the user 20 by a predetermined time. That is, given that the user position 30 is P, the velocity vector of the user 20 is v, and the predetermined time is t, the expected position can be represented as P+vt. The predetermined time t represents, for example, a time from a time point at which the position of the user 20 is observed to a time point at which the audio content 10 is output or a time point at which the audio content 10 reaches the user 20. For example, the time is set in advance on the basis of the processing performance of the audio content providing apparatus 2000. Here, the velocity vector of the user 20 can be computed on the basis of the temporal change of the user position 30.

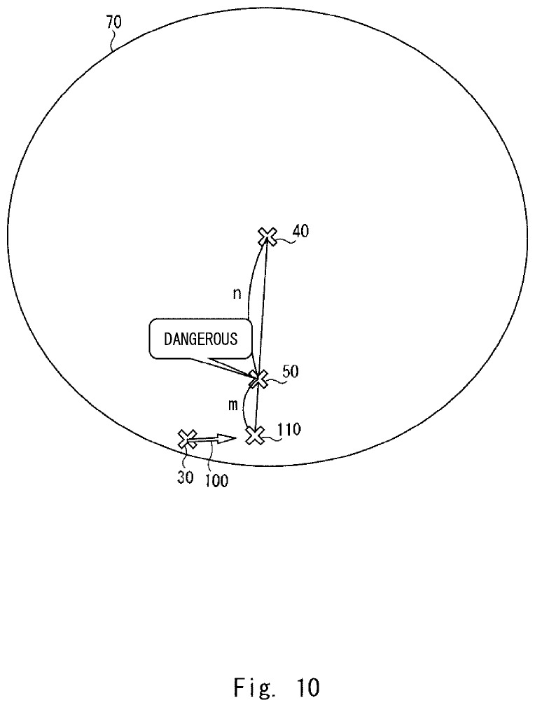

FIG. 10 is a diagram illustrating a case where the sound image localization position 50 is set using the expected position of the user 20. In FIG. 10, the velocity vector of the user 20 is represented by a reference numeral 100. Further, the expected position of the user 20 is represented by a reference numeral 110. The audio content providing apparatus 2000 sets a point obtained by internally dividing a line segment connecting the expected position 110 and the reference position 40 into men as the sound image localization position 50.

In the above description, the reference position 40 is in the target region 70. However, the reference position 40 may be outside the target region 70. Note that, even in a case where the reference position 40 is outside the target region 70, a method similar to that in the case where the reference position 40 is in the target region 70 can be adopted as a method for setting the sound image localization position 50.

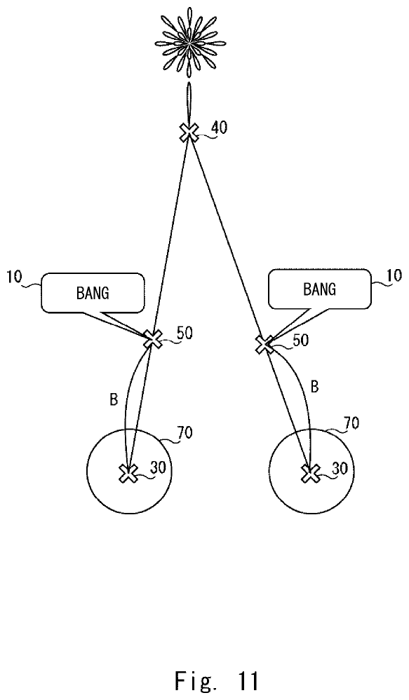

FIG. 11 is a diagram illustrating a case where the reference position 40 is outside the target region 70. In this example, the sound image localization position 50 is a position that is on a line segment connecting the user position 30 and the reference position 40 and that is separated from the user position 30 by a distance B.

In the example of FIG. 11, in response to the user 20 entering the target region 70, provision of a content to the user 20 is started at the reference position 40. For example, the content includes both visual content (such as video) and the audio content 10. As a more specific example, in response to the user 20 entering the target region 70, video of the firework is output at the reference position 40, and the audio content 10 such as the sound of the music or the firework in which a sound image is localized at the sound image localization position 50 is output.

Here, there is a case where the target region 70 is preferably provided at a position far from the reference position 40. For example, in a case where the visual content is large, in order for the user 20 to be able to view the entire content, the target region 70 that is a position at which the user 20 views the content needs to be located far from the reference position 40 to some extent. As a more specific example, in the case of viewing the firework, it is difficult for a viewer to view the entire firework unless the viewer is located at a position separated from the position where the firework is set off to some extent. Further, in a case where it is not desired to show, to the user 20, an apparatus or the like (for example, an apparatus for outputting video) used for providing the content or in a case where it is dangerous to approach the apparatus or the like, it is preferable to provide the target region 70 at a position far from the reference position 40.

On the other hand, in a case where the target region 70 is provided at a position far from the reference position 40 as described above, if the sound image of the audio content 10 is localized at the reference position 40, it may be difficult to provide an appropriate sound to the user 20. Suppose that the video of the firework is reproduced at the reference position 40 and the sound of the firework is output as the audio content 10. In this case, in order to give the user 20 a realistic feeling as if a real firework was set off in a state where the sound image of the audio content 10 is localized at the reference position 40, it is necessary to output the audio content 10 with a volume similar to the volume of the sound which the real firework emits at the set-off position. However, it is difficult to output the audio content 10 with such a volume.

Therefore, the audio content providing apparatus 2000 sets the sound image localization position 50 at which the sound image of the audio content 10 is localized to a position closer to the user position than the reference position 40. In this way, it is possible to reduce the volume of the audio content 10 necessary for providing an appropriate sound to the user 20 as compared with a case where the sound image of the audio content 10 is localized at the reference position 40.

As illustrated in FIG. 11, when the reference position 40 is outside the target region 70, a plurality of target regions 70 may be provided for one reference position 40.

<Output of Audio Content 10: 108>

The output control unit 2060 outputs the audio content 10 so as to localize the sound image of the audio content 10 at the sound image localization position 50 (S108). For this purpose, the output control unit 2060 performs audio signal processing for setting the position of the sound image localization to a specific position on the audio content 10, and then outputs the processed audio content 10. Here, an existing technique can be used as a technique for localizing a sound image at a desired position when audio data is output by performing the audio signal processing on the audio data.

Here, the output control unit 2060 controls a predetermined reproduction apparatus capable of outputting the sound and causes the reproduction apparatus to output the audio content 10. For example, the reproduction apparatus is an earphone, a headphone, or the like worn by the user 20 as described above.

In a case where the audio content 10 is output from the reproduction apparatus worn by the user 20 as described above, a direction of the face of the user 20 is used for the audio signal processing for controlling the sound image localization position of the audio content 10. Therefore, the output control unit 2060 determines the direction of the face of the user 20. The method for determining the direction of the face of the user 20 is as described above.

Further, in order to output the audio content 10 to the specific user 20, the output control unit 2060 needs to identify the user 20 to which the audio content 10 is to be output. In this regard, the audio content providing apparatus 2000 sets the sound image localization position 50 and outputs the audio content 10, in a case where it is detected that the user 20 enters the target region 70 using the user position information 80. For this reason, the output target of the audio content 10 is the user 20 who is detected to be in the target region 70 using the user position information 80. Therefore, the user 20 can be identified using the user position information 80 used for the detection.

For example, by including the identification information of the user 20 in the user position information 80, the audio content providing apparatus 2000 can identify the identification information of the user 20 determined to be in the target region 70. The audio content providing apparatus 2000 outputs the audio content 10 to the user 20 by using the identification information.

Here, as described above, suppose that the audio content 10 is output to the reproduction apparatus worn by the user 20. In this case, for example, the identification information of the user 20 and the identification information of the reproduction apparatus worn by the user 20 are stored in the storage unit in advance in association with each other. The output control unit 2060 identifies the identification information of the reproduction apparatus worn by the user 20 by accessing the storage unit, and causes the reproduction apparatus identified by the identification information to output the audio content 10. Note that the identification information of the reproduction apparatus may be used as the identification information of the user 20.

There are various methods for determining the audio content 10 to be provided to the user 20. For example, the audio content 10 is determined for each target region 70. In this case, for example, the audio content 10 provided in the target region 70 is stored in the storage unit in advance in association with the identification information of each of the one or more target regions 70. The output control unit 2060 acquires the audio content 10 associated with the identification information of the target region 70 for the target region 70 in which the user 20 is determined to be present.

The audio content 10 may be associated with the attribute of the target region 70. The attribute of the target region 70 is, for example, a type of a target object or the like in the target region 70. For example, the audio content 10 indicating a warning is associated with a type such as a dangerous object to be warned.

In another example, the audio content 10 may be determined taking the identification information and the attribute of the user 20 into consideration, in addition to the identification information and the attribute of the target region 70. The attribute of the user 20 is, for example, the age group, the language used, or the gender of the user 20. By using the identification information of the user 20 and the attribute of the user 20 as described above, it is possible to provide the audio content 10 more suitable for the user 20. For example, it is possible to change the content of the message represented by the audio content 10 according to whether the user 20 is an adult or a child, or it is possible to set the language of the message represented by the audio content 10 to be the same as the language used by the user 20.

Here, in a case where the plurality of sound image localization positions 50 are used as described above, the audio content that is output such that the sound image is localized at each of the sound image localization positions 50 may be the same content, or may be a plurality of different contents. In the latter case, for example, the output control unit 2060 divides one audio content 10 into a plurality of partial audio contents and uses different partial audio contents for each sound image localization position 50.

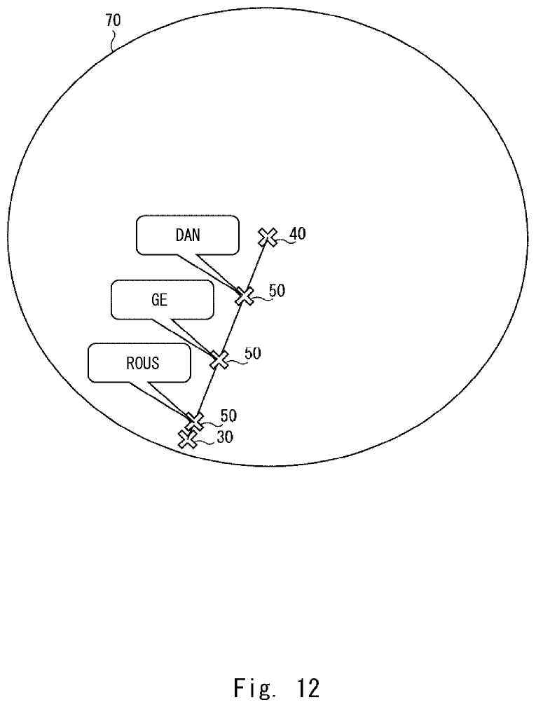

FIG. 12 is a diagram illustrating a case where a plurality of partial audio contents is output. In the example of FIG. 12, the audio content 10 is a sound representing a message “dangerous”. The output control unit 2060 divides the audio content 10 into partial audio content 12-1 representing a sound “dan”, partial audio content 12-2 representing a sound “ge”, and partial audio content 12-3 representing a sound “rous”. Then, the output control unit 2060 outputs the partial audio contents 12-1 to 12-3 so as to localize the sound images at the sound image localization positions 50-1 to 50-3, respectively.

Here, the number of divisions of the audio content 10 (how many partial audio contents 12 the audio content 10 is divided into) may be determined in advance, or may be dynamically determined. In the latter case, for example, the number of divisions of the audio content is determined on the basis of the distance between the user position and the reference position 40. For example, it is determined that one partial audio content 12 is output for each distance K. In this case, if the distance between the user position 30 and the reference position 40 is D, the number of divisions of the audio content 10 is represented by [D/K] or the like. Here, [D/K] represents a maximum integer of D/K or less. That is, when D/K is not an integer, a value of

D/K after the decimal point is truncated. However, the value after the decimal point may be rounded up or rounded off.

In addition, for example, the number of divisions of the audio content 10 may be determined on the basis of the time length of the audio content 10. The time length of the audio content 10 mentioned here is a length on the time axis of the sound represented by the audio content 10. For example, it is determined that one partial audio content 12 is generated for each time length T. In this case, the number of divisions of the audio content 10 is represented by [C/T] or the like when the time length of the audio content 10 is C. Note that, similarly to the case of determining the number of divisions on the basis of the distance, the value of C/T after the decimal point may also be rounded up or rounded off instead of being truncated.

### Second Example Embodiment

### <Overview>

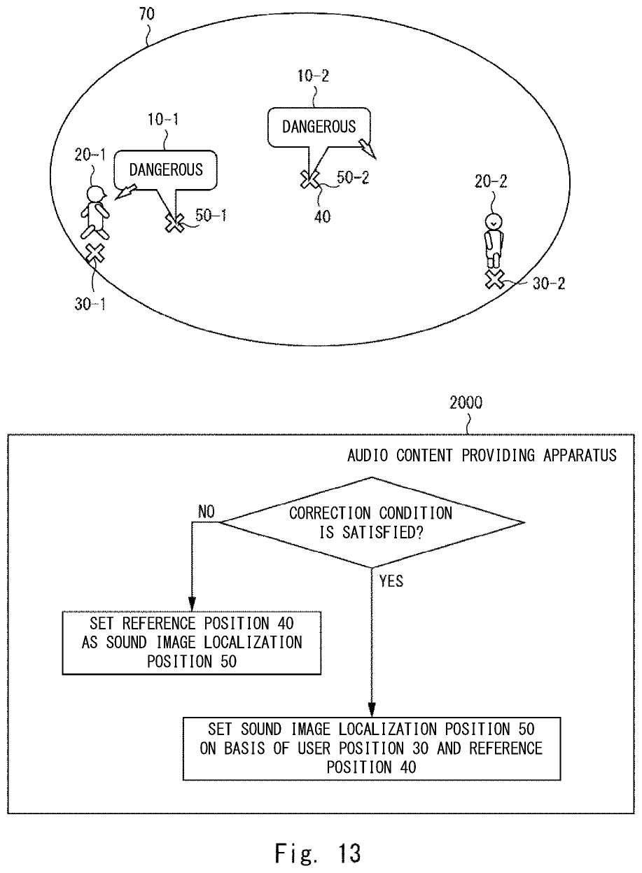

FIG. 13 is a diagram illustrating an overview of an operation of an audio content providing apparatus 2000 according to a second example embodiment. Here, FIG. 13 is a diagram for facilitating understanding of the overview of the audio content providing apparatus 2000, and the operation of the audio content providing apparatus 2000 is not limited to that illustrated in FIG. 1.

In the second example embodiment, the audio content providing apparatus 2000 uses either 1) a reference position 40 or 2) a correction position determined by the reference position 40 and a user position 30, as a sound image localization position 50. Here, a distance between the user position 30 and the correction position is shorter than a distance between the user position 30 and the reference position 40. Therefore, various positions (such as a position between the user position 30 and the reference position 40) set as the sound image localization position 50 in the audio content providing apparatus 2000 of the first example embodiment can be used as the correction position.

In order to determine which one of the reference position and the correction position is used as the sound image localization position 50, a predetermined correction condition is defined in advance. In a case where the correction condition is not satisfied, the audio content providing apparatus 2000 uses the reference position as the sound image localization position 50. On the other hand, in a case where the correction condition is satisfied, the audio content providing apparatus 2000 computes the correction position and uses the correction position as the sound image localization position 50.

For example, in the example of FIG. 13, a condition that “the probability that a user 20 moves toward a target object or the like is high” is used as the correction condition. In this case, for example, in a case where an angle formed by a direction from the user position 30 toward the reference position 40 and a movement direction of the user is equal to or less than a threshold value, or in a case where an entry angle of the user 20 with respect to a target region 70 is equal to or less than the threshold value, it is determined that the probability that the user 20 moves toward the target object or the like is high, and the correction condition is satisfied. On the other hand, in a case where the angle formed by the direction from the user position 30 toward the reference position 40 and the movement direction of the user 20 is larger than the threshold value, or in a case where the entry angle of the user 20 with respect to the target region 70 is larger than the threshold value, it is determined that the probability that the user moves toward the target object or the like is low, and the correction condition is not satisfied.

In FIG. 13, it is determined that the probability that a user 20-1 moves toward the target object or the like is high, and the correction condition is satisfied. Therefore, as a sound image localization position 50-1 for audio content 10-1 to be provided to the user 20-1, a correction position between a user position 30-1 and the reference position 40 is set instead of the reference position 40.

On the other hand, it is determined that the probability that a user 20-2 moves toward the target object or the like is low, and the correction condition is not satisfied. Therefore, the reference position is set as a sound image localization position 50-2 for audio content 10-2 to be provided to the user 20-2.

Note that a condition that “the probability that the user 20 moves toward the reference position 40 is high” is an example of the correction condition. As described later, various other conditions can be adopted as the correction condition.

### Example of Advantageous Effect

According to the audio content providing apparatus 2000 of the present example embodiment, either the reference position 40 or the correction position is used as the sound image localization position 50. Further, which one is used as the sound image localization position 50 is determined on the basis of whether the correction condition is satisfied or not. In this way, it is possible to appropriately control a position where a sound image of the audio content 10 is localized according to a situation.

Hereinafter, the audio content providing apparatus 2000 of the present example embodiment will be described in more detail.

### Example of Functional configuration

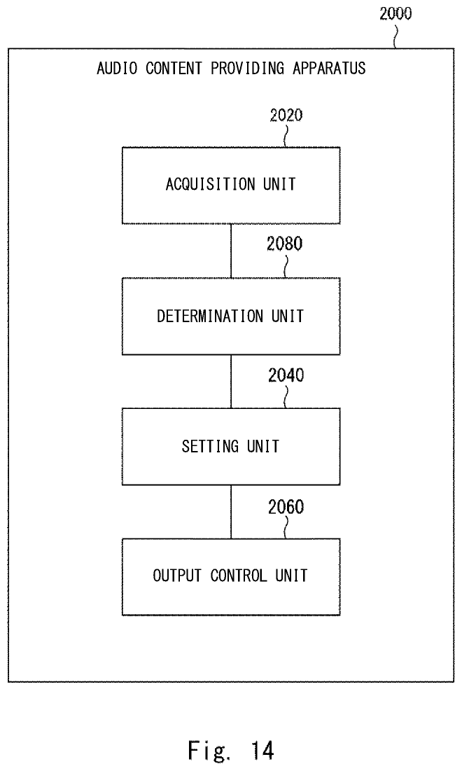

FIG. 14 is a block diagram illustrating a functional configuration of the audio content providing apparatus 2000 according to the second example embodiment. The audio content providing apparatus 2000 of the second example embodiment includes a determination unit 2080 in addition to functional configuration units included in the audio content providing apparatus 2000 of the first example embodiment. The determination unit 2080 determines whether or not the correction condition is satisfied. In a case where it is determined that the correction condition is satisfied, a setting unit 2040 computes the correction position and sets the correction position as the sound image localization position 50. On the other hand, in a case where the correction condition is not satisfied, the setting unit 2040 sets the reference position 40 as the sound image localization position 50.

### Example of Hardware Configuration

A hardware configuration of the audio content providing apparatus 2000 of the second example embodiment is similar to a hardware configuration of the audio content providing apparatus 2000 of the first example embodiment, and is illustrated in FIG. 3, for example. However, a storage device 508 of the second example embodiment further stores a program for realizing the function of the audio content providing apparatus 2000 of the second example embodiment.

### <Flow of Processing>

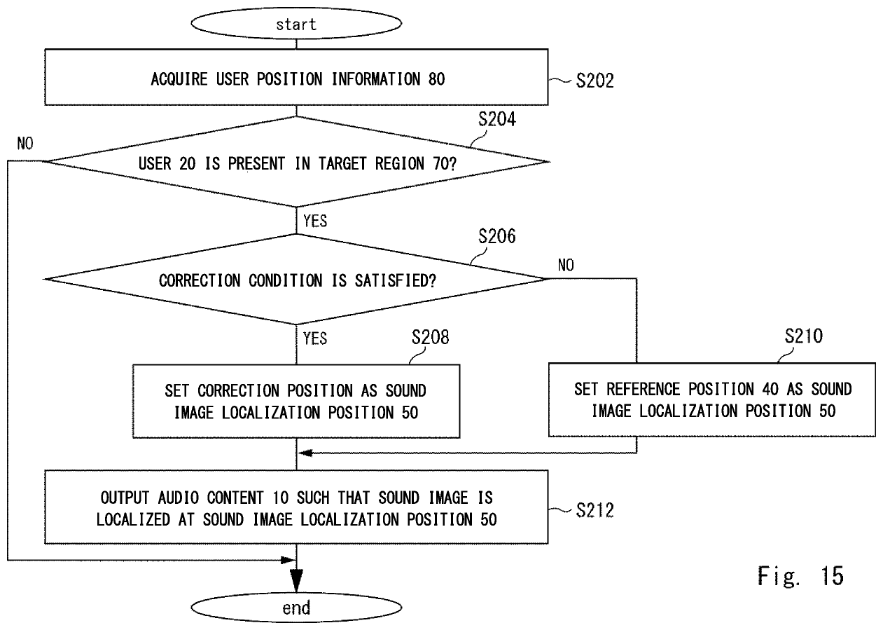

FIG. 15 is a flowchart illustrating a flow of processing executed by the audio content providing apparatus 2000 of the second example embodiment. An acquisition unit 2020 acquires user position information 80 (S202). The setting unit 2040 determines whether or not the user 20 is present in the target region 70 (S204). When the user 20 is not present in the target region 70 (S204: NO), the processing of FIG. 4 ends. On the other hand, when the user 20 is present in the target region 70 (S204: YES), the determination unit 2080 determines whether or not the correction condition is satisfied (S206).

When the correction condition is satisfied (S206: YES), the setting unit 2040 computes the correction position using the user position 30 and the reference position 40, and sets the correction position as the sound image localization position 50 (S208). On the other hand, when the correction condition is not satisfied (S206: NO), the setting unit 2040 sets the reference position 40 as the sound image localization position 50 (S210). An output control unit 2060 outputs the audio content 10 such that the sound image of the audio content 10 is localized at the sound image localization position 50 (S212).

### <Correction Condition>

As the correction condition, various conditions can be adopted. Hereinafter, some correction conditions will be exemplified.

For example, the correction condition is a condition that “the probability that the user 20 is in a dangerous state is high”. More specifically, a risk index value described in the first example embodiment can be used to adopt a correction condition that “the risk index value of the user 20 is equal to or more than a threshold value”.

By using such a correction condition, the sound image localization position 50 in a case where the probability that the user 20 is in a dangerous state is high is closer to the user position 30 than the sound image localization position 50 in a case where the probability that the user 20 is in a dangerous state is not high. Therefore, the sound image localization position of the audio content 10 can be appropriately controlled according to the state of the user 20.

Suppose that the audio content 10 represents guidance. In this case, in a case where the probability that the user 20 is in a dangerous state is high, the sound image of the audio content 10 is localized at the correction position closer than the reference position 40, so that an impression of the guidance on the user 20 can be strengthened. Further, in a case where the probability that the user 20 is in a dangerous state is not high, the sound image of the audio content 10 is localized at the reference position 40 farther than the correction position, so that the impression of the guidance on the user 20 can be relatively weakened. Therefore, it is possible to prevent the audio content 10 from giving an excessively strong impression to the user 20.

As the risk index, various indices described in the first example embodiment can be used. Suppose that the risk index value represents the magnitude of the movement speed of the user 20. In this case, when the movement speed of the user 20 is large, the correction condition is satisfied, and the correction position is used as the sound image localization position 50. On the other hand, when the movement speed of the user 20 is not large, the correction condition is not satisfied, and the reference position 40 is used as the sound image localization position 50.

In addition, suppose that the risk index value represents the probability that the user 20 does not notice the target object or the like. In this case, when the probability that the user 20 does not notice the target object or the like is high, the correction condition is satisfied, and the correction position is used as the sound image localization position 50. On the other hand, when the probability that the user 20 recognizes the target object or the like is high, the correction condition is not satisfied, and the reference position 40 is used as the sound image localization position 50.

In addition, suppose that the risk index value represents the probability that the user 20 moves toward the target object or the like. In this case, when the probability that the user 20 moves toward the target object or the like is high, the correction condition is satisfied, and the correction position is used as the sound image localization position 50. On the other hand, when the probability that the user 20 moves toward the target object or the like is not high, the correction condition is not satisfied, and the reference position 40 is used as the sound image localization position 50.

Examples of the correction condition other than the condition that “the probability that the user 20 is in a dangerous state is high” include a condition that “a state of the target object or the like is a predetermined state”. The predetermined state is, for example, a state to which the user 20 needs to pay attention.

First, a state to which the user 20 needs to pay attention to the state of the target object will be exemplified. For example, suppose that the target object is an object, such as a heavy machine, that can take an operating state and a non-operating state. In this case, the state to which the user 20 needs to pay attention is a state in which the target object is in operation. In addition, suppose that the target object is an object that handles a dangerous object such as a heavy machine (for example, an object transporting a dangerous object). In this case, the state to which the user 20 needs to pay attention is a state in which the target object handles a dangerous object. In addition, suppose that the target object is an object representing a content to be provided to the user, such as a firework. In this case, the state to which the user 20 needs to pay attention is a state in which the content represented by the target object is provided to the user (for example, a state in which a firework is set off).

Next, a state of a target place or event will be exemplified. For example, in a case where the target place is a place where a dangerous work is performed (construction site or the like), or in a case where the target event is the dangerous work, the state to which the user 20 needs to pay attention is a state in which the dangerous work is performed (a state in which a dangerous object is transported, a state in which an excavation work is performed, and the like.). In addition, for example, in a case where the target place is a place where a content is provided to the user 20, or in a case where the target event is an event where a content is provided to the user 20, the state to which the user 20 needs to pay attention is a state where content is provided to the user 20, or the like.

Here, a method for grasping the state of the target object or the like is arbitrary. For example, information indicating the state of the target object or the like is stored in an arbitrary storage unit. In this case, the setting unit 2040 can grasp the state of the target object or the like by accessing the storage unit. In addition, for example, the state of the target object or the like may be determined by analyzing a captured image obtained by capturing the target object or the like with a camera.

### <Output of Audio Content 10>

The output control unit 2060 outputs the audio content 10 such that the sound image is localized at the sound image localization position 50. Here, in a case where the correction condition is satisfied and a case where the correction condition is not satisfied, the same audio content 10 may be output, or different audio contents 10 may be output. In the latter case, the audio content 10 is prepared for each of the case where the correction condition is satisfied and the case where the correction condition is not satisfied. In the case where the correction condition is not satisfied, the output control unit 2060 outputs the audio content 10 prepared for the case where the correction condition is not satisfied. On the other hand, in the case where the correction condition is satisfied, the output control unit 2060 outputs the audio content 10 prepared for the case where the correction condition is satisfied.

Although the present invention has been described above with reference to the example embodiments, the present invention is not limited to the above-described example embodiments. Various changes that can be understood by those skilled in the art can be made to the configurations and details of the present invention within the scope of the present invention.

In the above-described example, the program includes a group of instructions (or software code) for causing the computer to perform one or more functions described in the example embodiment, when the program is read by the computer. The program may be stored in a non-transitory computer-readable medium or a tangible storage medium.

By way of an example and not by way of a limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. By way of an example and not by way of a limitation, the transitory computer-readable medium or the communication medium include electrical, optical, acoustic, or other forms of propagated signals.

Some or all of the above-described example embodiments may be described as in the following Supplementary Notes, but are not limited to the following Supplementary Notes.

(Supplementary Note 1)

An audio content providing apparatus comprising:
an acquisition unit configured to acquire user position information indicating a position of a user;
a setting unit configured to set a sound image localization position at which a sound image of audio content to be provided to the user is localized, on the basis of a reference position regarding a target object, place, or event and the user position, in a case where the user is present in a predetermined region; and
an output control unit configured to output the audio content such that the sound image is localized at the sound image localization position,
wherein a distance between the user position and the sound image localization position is shorter than a distance between the user position and the reference position.

(Supplementary Note 2)

The audio content providing apparatus according to supplementary note 1, wherein the setting unit sets a position on a straight line connecting the reference position and the user position as the sound image localization position.

(Supplementary Note 3)

The audio content providing apparatus according to supplementary note 1 or 2, wherein the setting unit sets a plurality of different sound image localization positions, and wherein the output control unit outputs the audio content subjected to sound image localization at each of the plurality of sound image localization positions at different timing.

(Supplementary Note 4)

The audio content providing apparatus according to supplementary note 3, wherein the plurality of sound image localization positions are used in order from a position closer to the reference position.

(Supplementary Note 5)

The audio content providing apparatus according to any one of supplementary notes 1 to 4, wherein the setting unit reduces the distance between the user position and the sound image localization position as a degree of danger of the user increases.

(Supplementary Note 6)

The audio content providing apparatus according to any one of supplementary notes 1 to 5, further comprising a determination unit configured to determine whether or not a predetermined correction condition is satisfied, wherein the setting unit performs:
setting the sound image localization position on the basis of the user position and the reference position in a case where the correction condition is satisfied, and
setting the reference position as the sound image localization position in a case where the correction condition is not satisfied.

(Supplementary Note 7)

The audio content providing apparatus according to supplementary note 6, wherein the correction condition is that a degree of danger of the user is equal to or more than a threshold value, or that a state of the target object, place, or event is a state to which the user needs to pay attention.

(Supplementary Note 8)

The audio content providing apparatus according to supplementary note 7, wherein the degree of danger of the user is represented by: a magnitude of a movement speed of the user; a probability that the user notices the target object, place, or event; or a probability that the user moves toward the target object, place, or event.

(Supplementary Note 9)

The audio content providing apparatus according to supplementary note 7, wherein the state to which the user needs to pay attention is a state in which the target object is in operation, a state in which the target object handles a dangerous object, a state in which a content represented by the target object is provided to the user, a state in which a dangerous work is performed in the target place, a state in which a content is provided to the user in the target place, or a state in which the target event is performed.

(Supplementary Note 10)

A control method executed by a computer, the control method comprising:
an acquisition step of acquiring user position information indicating a position of a user;
a setting step of setting a sound image localization position at which a sound image of audio content to be provided to the user is localized on the basis of a reference position regarding a target object, place, or event and the user position, in a case where the user is present in a predetermined region; and
an output control step of outputting the audio content such that the sound image is localized at the sound image localization position,
wherein a distance between the user position and the sound image localization position is shorter than a distance between the user position and the reference position.

(Supplementary Note 11)

The control method according to supplementary note 10, wherein, in the setting step, setting a position on a straight line connecting the reference position and the user position as the sound image localization position.

(Supplementary Note 12)

The control method according to supplementary note 10 or 11, wherein in the setting step, setting a plurality of different sound image localization positions, and in the output control step, outputting the audio content subjected to sound image localization at each of the plurality of sound image localization positions at different timing.

(Supplementary Note 13)

The control method according to supplementary note 12, wherein the plurality of sound image localization positions are used in order from a position closer to the reference position.

(Supplementary Note 14)

The control method according to any one of supplementary notes 10 to 13, wherein, in the setting step, reducing the distance between the user position and the sound image localization position as a degree of danger of the user increases.

(Supplementary Note 15)

The control method according to any one of supplementary notes 10 to 14, further comprising a determination step of determining whether or not a predetermined correction condition is satisfied,
wherein, in the setting step:
   setting the sound image localization position on the basis of the user position and the reference position in a case where the correction condition is satisfied; and
   setting the reference position as the sound image localization position in a case where the correction condition is not satisfied.

(Supplementary Note 16)

The control method according to supplementary note 15, wherein the correction condition is that a degree of danger of the user is equal to or more than a threshold value, or that a state of the target object, place, or event is a state to which the user needs to pay attention.

(Supplementary Note 17)

The control method according to supplementary note 16, wherein the degree of danger of the user is represented by: a magnitude of a movement speed of the user; a probability that the user recognizes the target object, place, or event; or a probability that the user moves toward the target object, place, or event.

(Supplementary Note 18)

The control method according to supplementary note 16, wherein the state to which the user needs to pay attention is a state in which the target object is in operation, a state in which the target object handles a dangerous object, a state in which a content represented by the target object is provided to the user, a state in which a dangerous work is performed in the target place, a state in which a content is provided to the user in the target place, or a state in which the target event is performed.

(Supplementary Note 19)

A computer-readable medium storing a program that causes a computer to execute:
an acquisition step of acquiring user position information indicating a position of a user;
a setting step of setting a sound image localization position at which a sound image of audio content to be provided to the user is localized on the basis of a reference position regarding a target object, place, or event and the user position, in a case where the user is present in a predetermined region; and
   an output control step of outputting the audio content such that the sound image is localized at the sound image localization position,
   wherein a distance between the user position and the sound image localization position is shorter than a distance between the user position and the reference position.

(Supplementary Note 20)

The computer-readable medium according to supplementary note 19, wherein, in the setting step, setting a position on a straight line connecting the reference position and the user position as the sound image localization position.

(Supplementary Note 21)

The computer-readable medium according to supplementary note 19 or 20, wherein in the setting step, setting a plurality of different sound image localization positions, and in the output control step, outputting the audio content subjected to sound image localization at each of the plurality of sound image localization positions at different timing.

(Supplementary Note 22)

The computer-readable medium according to supplementary note 21, wherein the plurality of sound image localization positions are used in order from a position closer to the reference position.

(Supplementary Note 23)

The computer-readable medium according to any one of supplementary notes 19 to 22, wherein, in the setting step, reducing the distance between the user position and the sound image localization position as a degree of danger of the user increases.

(Supplementary Note 24)

The computer-readable medium according to any one of supplementary notes 19 to 23, further comprising a determination step of determining whether or not a predetermined correction condition is satisfied,
wherein, in the setting step:
   setting the sound image localization position on the basis of the user position and the reference position in a case where the correction condition is satisfied; and
   setting the reference position as the sound image localization position in a case where the correction condition is not satisfied.

(Supplementary Note 25)

The computer-readable medium according to supplementary note 24, wherein the correction condition is that a degree of danger of the user is equal to or more than a threshold value, or that a state of the target object, place, or event is a state to which the user needs to pay attention.

(Supplementary Note 26)

The computer-readable medium according to supplementary note 25, wherein the degree of danger of the user is represented by: a magnitude of a movement speed of the user; a probability that the user recognizes the target object, place, or event; or a probability that the user moves toward the target object, place, or event.

(Supplementary Note 27)

The computer-readable medium according to supplementary note 25, wherein the state to which the user needs to pay attention is a state in which the target object is in operation, a state in which the target object handles a dangerous object, a state in which a content represented by the target object is provided to the user, a state in which a dangerous work is performed in the target place, a state in which a content is provided to the user in the target place, or a state in which the target event is performed.

### REFERENCE SIGNS LIST

20 USER
30 USER POSITION
40 REFERENCE POSITION
50 SOUND IMAGE LOCALIZATION POSITION
70 TARGET REGION
80 USER POSITION INFORMATION
90 REGION
100 VELOCITY VECTOR
110 EXPECTED POSITION
500 COMPUTER
502 BUS
504 PROCESSOR
506 MEMORY
508 STORAGE DEVICE
510 INPUT/OUTPUT INTERFACE
512 NETWORK INTERFACE
2000 AUDIO CONTENT PROVIDING APPARATUS
2020 ACQUISITION UNIT
2040 SETTING UNIT
2060 OUTPUT CONTROL UNIT
2080 DETERMINATION UNIT

What is claimed is:

1. An audio content providing apparatus comprising:
at least one memory that is configured to store instructions; and
at least one processor that is configured to execute the instructions to:
acquire user position information indicating a position of a user;
set a sound image localization position at which a sound image of audio content to be provided to the user is localized, on the basis of a reference position regarding a target object, place, or event and the user position, in a case where the user is present in a predetermined region; and
output the audio content such that the sound image is localized at the sound image localization position,
wherein a distance between the user position and the sound image localization position is shorter than a distance between the user position and the reference position.

2. The audio content providing apparatus according to claim 1, wherein the setting of the sound image localization position further includes setting a position on a straight line connecting the reference position and the user position as the sound image localization position.

3. The audio content providing apparatus according to claim 1,
wherein the setting of the sound image localization position further includes setting a plurality of different sound image localization positions, and
wherein the outputting of the audio content further includes outputting the audio content subjected to sound image localization at each of the plurality of sound image localization positions at different timing.

4. The audio content providing apparatus according to claim 3, wherein the plurality of sound image localization positions are used in order from a position closer to the reference position.

5. The audio content providing apparatus according to claim 1, wherein the setting of the sound image localization position further includes reducing the distance between the user position and the sound image localization position as a degree of danger of the user increases.

6. The audio content providing apparatus according to claim 1, wherein the at least one processor is configured to execute the instructions further to determine whether or not a predetermined correction condition is satisfied,
wherein the setting of the sound image localization position further includes:
setting the sound image localization position on the basis of the user position and the reference position in a case where the correction condition is satisfied, and
setting the reference position as the sound image localization position in a case where the correction condition is not satisfied.

7. The audio content providing apparatus according to claim 6, wherein the correction condition is that a degree of danger of the user is equal to or more than a threshold value, or that a state of the target object, place, or event is a state to which the user needs to pay attention.

8. The audio content providing apparatus according to claim 7, wherein the degree of danger of the user is represented by: a magnitude of a movement speed of the user; a probability that the user notices the target object, place, or event; or a probability that the user moves toward the target object, place, or event.

9. The audio content providing apparatus according to claim 7, wherein the state to which the user needs to pay attention is a state in which the target object is in operation, a state in which the target object handles a dangerous object, a state in which a content represented by the target object is provided to the user, a state in which a dangerous work is performed in the target place, a state in which a content is provided to the user in the target place, or a state in which the target event is performed.

10. A control method executed by a computer, the control method comprising:
acquiring user position information indicating a position of a user;
setting a sound image localization position at which a sound image of audio content to be provided to the user is localized on the basis of a reference position regarding a target object, place, or event and the user position, in a case where the user is present in a predetermined region; and
outputting the audio content such that the sound image is localized at the sound image localization position,
wherein a distance between the user position and the sound image localization position is shorter than a distance between the user position and the reference position.

11. The control method according to claim 10, wherein the setting of the sound image localization position further includes setting a position on a straight line connecting the reference position and the user position as the sound image localization position.

12. The control method according to claim 10,
wherein the setting of the sound image localization position further includes setting a plurality of different sound image localization positions, and
the outputting of the audio content further includes outputting the audio content subjected to sound image localization at each of the plurality of sound image localization positions at different timing.

13. The control method according to claim 12, wherein the plurality of sound image localization positions are used in order from a position closer to the reference position.

14. The control method according to claim 10, wherein the setting of the sound image localization position further includes reducing the distance between the user position and the sound image localization position as a degree of danger of the user increases.

15. The control method according to claim 10, further comprising determining whether or not a predetermined correction condition is satisfied,
wherein the setting of the sound image localization position further includes:
setting the sound image localization position on the basis of the user position and the reference position in a case where the correction condition is satisfied; and
setting the reference position as the sound image localization position in a case where the correction condition is not satisfied.

16. The control method according to claim 15, wherein the correction condition is that a degree of danger of the user is equal to or more than a threshold value, or that a state of the target object, place, or event is a state to which the user needs to pay attention.

17. The control method according to claim 16, wherein the degree of danger of the user is represented by: a magnitude of a movement speed of the user; a probability that the user recognizes the target object, place, or event; or a probability that the user moves toward the target object, place, or event.

18. The control method according to claim 16, wherein the state to which the user needs to pay attention is a state in which the target object is in operation, a state in which the target object handles a dangerous object, a state in which a content represented by the target object is provided to the user, a state in which a dangerous work is performed in the target place, a state in which a content is provided to the user in the target place, or a state in which the target event is performed.

19. A non-transitory computer-readable medium storing a program that causes a computer to execute:
acquiring user position information indicating a position of a user;
setting a sound image localization position at which a sound image of audio content to be provided to the user is localized on the basis of a reference position regarding a target object, place, or event and the user position, in a case where the user is present in a predetermined region; and
outputting the audio content such that the sound image is localized at the sound image localization position,
wherein a distance between the user position and the sound image localization position is shorter than a distance between the user position and the reference position.

20. The medium according to claim 19, wherein the setting of the sound image localization position further includes setting a position on a straight line connecting the reference position and the user position as the sound image localization position.

21. The medium according to claim 19,
wherein the setting of the sound image localization position further includes setting a plurality of different sound image localization positions, and
the outputting of the audio content further includes outputting the audio content subjected to sound image localization at each of the plurality of sound image localization positions at different timing.

22. The medium according to claim 21, wherein the plurality of sound image localization positions are used in order from a position closer to the reference position.

23. The medium according to claim 19, wherein the setting of the sound image localization position further includes reducing the distance between the user position and the sound image localization position as a degree of danger of the user increases.

24. The medium according to claim 19,
wherein the program causes the computer further execute determining whether or not a predetermined correction condition is satisfied,
wherein the setting of the sound image localization position further includes:
setting the sound image localization position on the basis of the user position and the reference position in a case where the correction condition is satisfied; and
setting the reference position as the sound image localization position in a case where the correction condition is not satisfied.

25. The medium according to claim 24, wherein the correction condition is that a degree of danger of the user is equal to or more than a threshold value, or that a state of the target object, place, or event is a state to which the user needs to pay attention.

26. The medium according to claim 25, wherein the degree of danger of the user is represented by: a magnitude of a movement speed of the user; a probability that the user recognizes the target object, place, or event; or a probability that the user moves toward the target object, place, or event.

27. The medium according to claim 25, wherein the state to which the user needs to pay attention is a state in which the target object is in operation, a state in which the target object handles a dangerous object, a state in which a content represented by the target object is provided to the user, a state in which a dangerous work is performed in the target place, a state in which a content is provided to the user in the target place, or a state in which the target event is performed.
